(19) United States
(12) Patent Application Publication
(10) Pub. No.: US 2014/0111414 A1
(43) Pub. Date: Apr. 24, 2014

(54) Instrumented Apparel for the Collection of Kinematic Motion

(71) Applicant: David Alan Hayner, Austin, TX (US)

(72) Inventor: David Alan Hayner, Austin, TX (US)

(21) Appl. No.: 13/656,100

(22) Filed: Oct. 19, 2012

(51) Int. Cl. G06F 3/01

(52) U.S. Cl. CPC G06F 3/017
USPC 345/156

(57) ABSTRACT

Apparatus and methods for repetitive and consistent collection, processing, feedback, storage, communication and use of data generated by one or more sensors and feedback devices embedded in apparel or orthodics worn by a user.

### CROSS-REFERENCE TO RELATED APPLICATIONS

Provisional Utility Patent Application No. 61/627,936 with filing date Oct. 21, 2011, Atty. Docket No. DH_{—}15_{—}003_P.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field addressing applications of sensors integrated with clothing apparel. More specifically, this invention discloses methods essential to the effective employment of one or more sensors, digital processing systems and storage or communications devices to collect, process and communicate data associated with kinematic motions of the wearer's body, limbs, appendages, etc., while engaged in various activities.

The data collected by this sensor network can be used to continuously measure the motions of the wearer's body and individual limbs and hand during activities and via various other devices, provide feedback to the user concerning these motions. These measures and feedback can be employed in gaming, medical and physiological research, remote control of objects, training, rehab, monitoring and a variety of other applications. Furthermore, other desirable features and characteristics of the embodiments presented here will become apparent from the subsequent detailed description taken in conjunction with the accompanying drawings and this background.

### SUMMARY OF THE INVENTION

The present invention employs an array of sensors, feedback devices providing stimulus to the user and methods for integrating these sensors and feedback devices into apparel, programmable data processor, storage media and/or communications systems to measure, process, respond to, and record the kinematic motions of an animal or human body wearing apparel containing this array of sensors and feedback devices.

### BRIEF DESCRIPTION OF THE DRAWINGS

Various embodiments will hereinafter be described in conjunction with the following figures, wherein like numerals denote like elements, and

FIG. 1 is a diagram of a set of sensors, feedback devices, processor, storage and communications systems configured in a shirt in accordance with one embodiment of the invention;

FIG. 2 is a diagram of a set of sensors, feedback devices, processor, storage and communication systems configured in a functional structure in accordance with one embodiment of the invention;

FIG. 3 is a schematic diagram that illustrates 3^{rd} party use of the data collected by the system of FIGS. 1-2.

FIG. 4 is a diagram illustrating the implementation of various alignment aids and user interface devices on a representative article of apparel.

### DETAILED DESCRIPTION OF EMBODIMENTS

The following detailed description is merely exemplary in nature and is not intended to limit the scope or the application and uses of the described embodiments. Furthermore, there is no intention to be bound by any theory presented in the preceding background or the following detailed description.

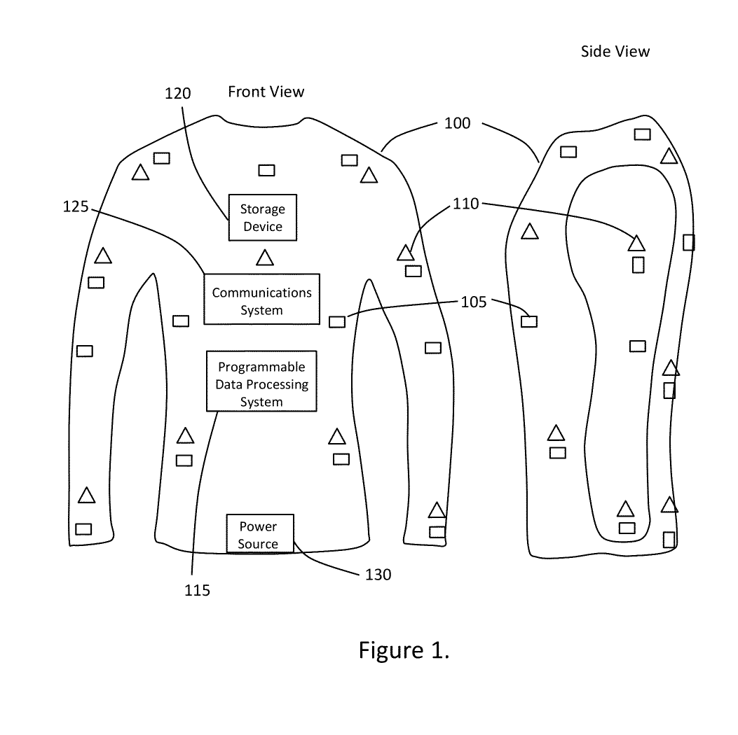

Referring now to the invention, FIG. 1 illustrates 1 or more sensors 105 embedded in the fabric of a shirt 100. As illustrated in FIG. 1, these sensors 105 are distributed throughout the three-dimensional structure of the shirt 100 in such a way as to collect data concerning kinematic motion of the body wearing this shirt (apparel). The sensor arrangement illustrated is only an example to demonstrate the three-dimensional distribution of the sensors 105 in the shirt 100. Clearly, this array of sensors could also be distributed throughout the structure of pants, leggings, sleeves, gloves, or other forms of apparel.

These sensors 105 may consist of accelerometers, gyroscopes, pressure, acoustic, temperature, magnetic, optical, torsion, tension, force or other such measures of motion and/or applied forces. These sensors 105 may be arranged in any number of combinations, structures and relationships.

Data generated by these sensors is collected by a programmable data processing system 115 which causes this data to be stored in storage device 120. This storage media may be non-volatile and/or removable in order to facilitate retrieval of the stored data. In a typical application, software running on the programmable data processing system will cause the sensor data to be stored in storage device 120. Alternately, data collected by the programmable data processing system 115 may be continuously communicated to an external system via communications system 125. Data may be stored for later use in this external system or used immediately. This communication of data may be performed in parallel to internal storage in storage device 120. Additionally storage device 120 may also be used for buffering the flow of data to the communications system 125.

Also illustrated in FIG. 1 is a set of feedback devices 110. These feedback devices are intended to provide localized or general feedback to the user concerning the motions they are executing. This feedback may be mechanical and provide a local vibration or motion that can be felt by the user. Other forms of mechanical feedback such as tension (or lack of tension) or push/pull may also provide sufficient feedback to alert the user. Alternately, electrical stimulation, audio/acoustic, thermal or optical sources may also be used to provide localized or general feedback to the user.

The system illustrated in FIG. 1 is powered by a power source 130 which may be a battery or other power source that may be integral to the apparel or may be provided by a remote power system worn by the user or co-located with the user.

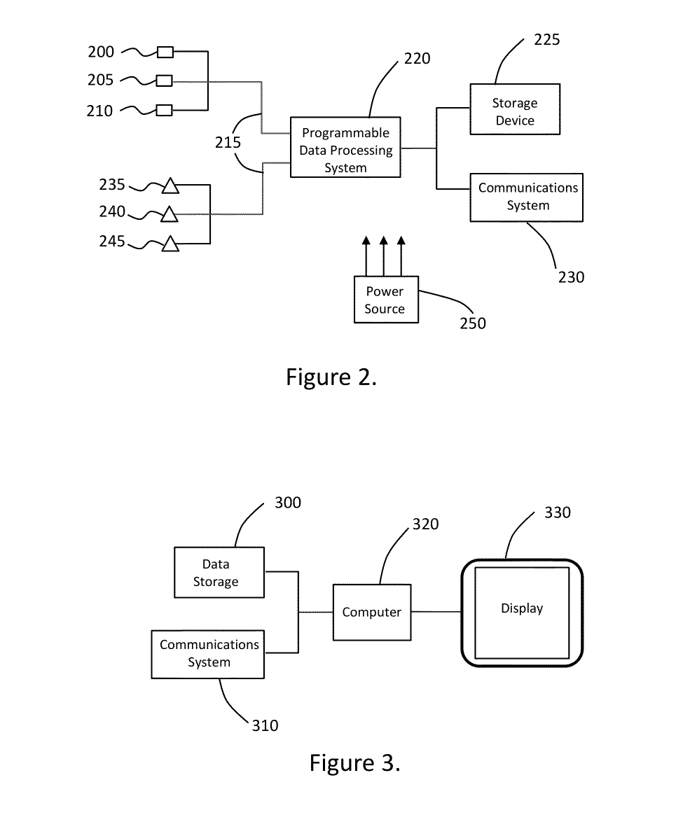

FIG. 2 illustrates a subset of sensors 200, 205 and 210, feedback devices 235, 240, 245 in one possible configuration coupled to the central processing system 220. Programmable data processing system 220 is connected to storage device 225, communications system 230 and power source 250. The function of the programmable data processing system is to collect and possibly format, encrypt, compress, and/or analyze data generated by the array of sensors. The programmable data processing system can be programmed in a variety of methods to facilitate the collection and use of the sensor generated data. In a typical mode, the programmable data processing system 220 is continuously storing sensor data in storage device 225. In parallel to this operation, the programmable data processing system 220 may also be communicating the sensor data to an external system via communications system 230. The storage device 225 may be, for example, a flash memory device or other removable mass storage element. Storage device 225 may also consist of volatile storage media which maintains memory via continuous power and the data is downloaded via the communications system 230. The communications system may be for example, any of a number of wireless or wireline communication systems.

The programmable data processing system 220 may, as a result of the processing of data collected from the array of sensors 200, 205, 210, determine that specific feedback should be applied to one or more of the feedback devices 235, 240, 245 to alter the user to some condition. Alternately, this feedback may be a result of information or commands received by the programmable data processing system 220 via the communications system 230.

Programmable data processing system 220 may be any integrated circuit device configured for a particular purpose. As such, programmable data processing system 220 may be any application specific integrated circuit (ASIC) device known in the art or developed in the future, a microprocessor or other related signal processing system.

It may also be desirable to provide means by which the programmable data processing system 220 can be updated or reprogrammed while the system is in use. In this scenario, the communications system 230 can use used to either command alternate programs to be executed by the programmable data processing system 220 or new programs or parameters for existing programs can be sent to the programmable data processing system 220 via the communications system 230.

The previous discussion is not intended to limit the specific numbers, types and arrangements of sensors and/or feedback devices or the specific processing methods and applications. References to specific techniques are used only as a means to explain an example of the art. Those skilled in these methods are aware of many alternate methods that can be employed.

In FIG. 3 is a retrieval and data exploitation system. This can be a typical PC, laptop, tablet, smart-phone or other data processing and display system capable of receiving data from the instrumented apparel. This data transfer may be accomplished via physical removal of storage media from the apparel and insertion into the data exploitation system as illustrated with data storage 300. The data transfer may be wire or wireless communicated from the apparel to the data exploitation system via the communications system 310. This data may also be retrieved from a 3^{rd} party device to which the data was sent.

The computer in FIG. 3 is programmed to reformat the data, decompress, decrypt and possibly provide various analysis and display capabilities to enable the user to view or use the data in a variety of ways. Methods involved in the analysis and display will be specific to the applications for which the data collected by the sensors in the apparel are intended.

In many applications, it is desirable that the apparel can be removed and re-applied in a manner which repeatedly places the sensors and/or feedback devices in substantially the same set of locations on the body from one removal and re-application to the next. In this case, re-apply or re-application refers to the action of putting the apparel back on the body. Removing or removal refers to the action of taking the apparel off the body. For instance, consider a sleeve to be used on the arm and this sleeve has 2 sensors. The first sensor is intended to be located on the extensor approximately six inches below the elbow. The second sensor is intended to be located on the triceps approximately three inches above the elbow.

Alternately, it may be desirable that the user can remove and re-apply the sleeve in a manner which places the sensors and feedback devices in substantially the same set of locations from one application to the next. The specific locations are somewhat irrelevant as long as the sensors and possibly the feedback device(s) are consistently located on the body from one application to the next.

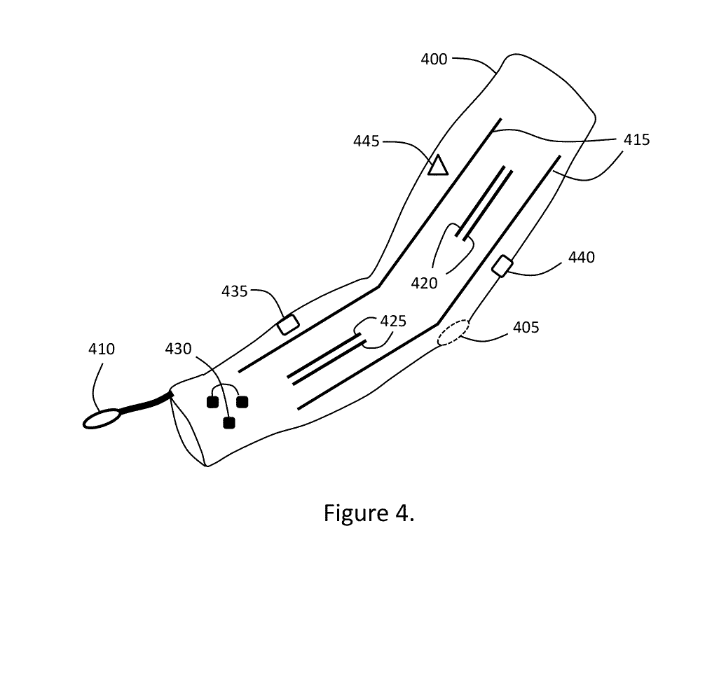

Illustrated in FIG. 4 is a representative article of apparel. In this particular case, a sleeve for use on a human arm. Illustrated in FIG. 4 are a number of features enabling the repeatable re-application of the sleeve. While the methods employed are described in relation to a sleeve intended to be worn on the arm, variations and extension of these methods for use on other body structures will be evident to those skilled in these arts.

In FIG. 4, the sleeve 400 contains two sensors, 435 located on the extensor and sensor 440 located on the triceps. Alignment strips 415 contained as part of the sleeve are intended to aid the user in repeatable alignment of the sleeve. Additionally, an elbow cutout 405 and/or a thumb catch loop 410 may be included both to aid in alignment and to help maintain position of the sleeve during use. The alignment strips 415 may be visible markings or may be combinations of visible markings and mechanical stays or other devices embedded in the sleeve to aid in the consistent re-application of the sleeve.

While the previous discussion has implied the use of continuous material for the sleeve, the same methods can be employed with exo-skeleton types of devices (braces) for placing the sensors and possibly the feedback devices in repeatable locations. These exo-skeleton structures can also provide a variety of means for supporting user interface devices.

Also illustrated in FIG. 4 are a set of user interface devices. Strips 420 and 425 may both serve as alignment devices and electrical contact devices for user inputs. Pads 430 may also serve as electrical or mechanical user control inputs.

In some applications, it may be desirable that the sensors be positioned on the body in such a way as to minimize the influence of body muscle and tendon flex on the measure of the motions of body structures. If for example, the objective is to measure the skeletal motion of a user's arm during the execution of a forearm curl, a sensor placed on many locations on the user's bicep muscle could measure a combination of signals. One set of signals is due to the skeletal motions associated with the curl. Other signals may be associated with the bicep muscle action providing a principal driving force to the skeleton to execute the curl. If the sensor was placed on the triceps, substantially the same skeletal information could be measured but with less interfering data from bicep, or other muscle actions. Similar relationships exist for a wide variety of exercises and motions. As noted, it may be desirable to locate the sensors, and/or only employ data from subsets of sensors in manners corresponding to minimal (or possibly maximal) influence of related or unrelated body actions.

In summary, systems, devices, and methods configured in accordance with exemplary embodiments relate to:

Apparel augmented with one or more sensors, feedback devices, user interface means, a programmable data processing system, communications systems, a data storage system and a power supply. The programmable data processing system is configured to collect data from the sensor(s), possibly provide signals to the feedback devices corresponding to certain motions or actions measured by the sensors, store data in a storage system for later retrieval and/or communicate this data, or derivatives of the sensor data to external systems. In certain embodiments, the sensors may be one or more of an accelerometer, gyroscope, pressure, acoustic, temperature, magnetic, optical, torsion, tension or force measuring devices. Feedback devices may be one or more of mechanical, electrical, optical, thermal or acoustic. These feedback devices may be an integral part of the apparel or may be independent of the apparel. For instance a set of ear buds for audio feedback may be an option.

The sensor augmented apparel described above in which data may be stored and/or communicated to external devices via wireless or wireline communication systems. This communication process may occur simultaneously with data collection or be delayed to a future time for off-loading the data to an external system.

The sensor augmented apparel described above in which external commands received over a communications system may trigger specific feedback signals to one or more of the feedback devices.

The sensor augmented apparel described above in which the processing system can be re-programmed to process the data in alternate ways prior to storage or transmission or feedback to the user.

The sensor augmented apparel described above together with data exploitation systems designed to display, analyze or process the data to provide analysis and review of the data collected by the sensors contained in the apparel.

The sensor augmented apparel described above including alignment aids to enable the consistent re-application of the apparel such the sensors and possibly the feedback devices are placed and maintained in substantially the same sets of positions from one re-application to the next.

The sensor augmented apparel described above including a various electrical and/or mechanical user interface devices.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention.

What is claimed:

1. A unit of wearable apparel designed for wear on an arm, leg, upper torso, lower torso or any combination of limbs and body structure, constructed to maintain sensors and feedback devices in particular positions during use and to reproduce these positions from one re-application of the unit to the next, this unit of wearable apparel comprising:
an array of one or more sensors integrated into said unit of wearable apparel and configured to generate outputs measuring the structural motions of the body structure to which the sensors are mounted and said sensors are networked together in a manner enabling data processing devices to acquire this sensor data;
an array of one or more feedback devices integrated into said unit of wearable apparel and configured to generate an output intended to be detectable by the wearer of said unit and these feedback devices are networked together in a manner enabling data processing devices to deliver signals to said feedback devices; and
user interface devices integrated into said wearable apparel and networked together in a manner enabling data processing devices to associate specific user inputs with specific user interface devices.

2. The unit of wearable apparel described in claim 1 augmented with alignment marks, stripes, colors or other visual or tactile indicators enabling repetitive re-application of said unit of wearable apparel to specific body structures resulting in each of the multiple sensors and feedback units reset and maintained in substantially the same body position from one re-application to the next.

3. The unit of wearable apparel described in claim 1 augmented with mechanical aids such as flexible, semi-flexible or fixed stays, embedded or external structures designed to enable repetitive re-application of said unit of wearable apparel to specific body structures resulting in each of the multiple sensors and feedback units reset and maintained in substantially the same body position from one re-application to the next.

4. The unit of wearable apparel described in claim 1 augmented with combinations of visual and tactile indicators and mechanical aids to enable repetitive re-application of said unit of wearable apparel to specific body structures resulting in each of the multiple sensors and feedback units reset and maintained in substantially the same body position from one re-application to the next.

5. The unit of wearable apparel described in claim 1 augmented with a programmable data processing system, data storage devices and communications systems enabling the collection and processing of data from said sensor arrays, providing signals to said feedback devices and communicating with 3^{rd} party external systems.

6. The unit of wearable apparel described in claim 1 in which one or more feedback devices connected to programmable data processor is external to said unit of wearable apparel.

7. A brace device designed for wear on an arm, leg, upper torso, lower torso or any combination of limbs and body structure, constructed to maintain sensors and feedback devices in particular positions during use and to reproduce these positions from one re-application of the brace device to the next, this brace device comprising:
an array of one or more sensors integrated into said brace device and configured to generate outputs measuring the structural motions of the body structures to which the sensors are mounted and said sensors are networked together in a manner enabling data processing devices to acquire this sensor data;
an array of one or more feedback devices integrated into said brace device and configured to generate an output intended to be detectable by the wearer of said brace device and these feedback devices are networked together in a manner enabling data processing devices to communicate with said feedback devices; and
user interface devices integrated into said brace device and networked together in a manner enabling data processing devices to associate specific user inputs with specific user interface devices.

8. The brace device described in claim 7 augmented with alignment marks, stripes, colors or other visual or tactile indicators enabling repetitive re-application of said brace device to specific body structures resulting in each of the multiple sensors and feedback units reset and maintained in substantially the same body position from one re-application to the next.

9. The brace device described in claim 7 augmented with mechanical aids such as flexible, semi-flexible or fixed stays, embedded or external structures designed to enable repetitive re-application of said brace device to specific body structures resulting in each of the multiple sensors and feedback units reset and maintained in substantially the same body position from one re-application to the next.

10. The brace device described in claim 7 augmented with combinations of visual and tactile indicators and mechanical aids enabling the repetitive re-application of said brace device to specific body structures resulting in each of the multiple sensors and feedback units reset and maintained in substantially the same body position from one re-application to the next.

11. The brace device described in claim 7 augmented with a programmable data processing system, data storage devices and communications systems enabling the collection and processing of data from said sensor arrays, providing signals to said feedback devices and communicating with 3^{rd} party external systems.

12. The brace device described in claim 7 in which one or more feedback devices connected to programmable data processor are external to said brace device.

13. The unit of wearable apparel described in claim 1 wherein the sensors may be any combination or arrangement of one or more accelerometers, gyroscopes, pressure, acoustic, temperature, magnetic, optical, torsion, tension, force or other such measures of motion and/or applied forces.

14. The brace device described in claim 7 wherein the sensors may be any combination or arrangement of one or more accelerometers, gyroscopes, pressure, acoustic, temperature, magnetic, optical, torsion, tension, force or other such measures of motion and/or applied forces.

15. The unit of wearable apparel described in claim 1 wherein the feedback devices may be any combination or arrangement of one or more of mechanical, electrical, optical, thermal or acoustic.

16. The brace device described in claim 7 wherein the feedback devices may be any combination or arrangement of one or more of mechanical, electrical, optical, thermal or acoustic.

17. The unit of wearable apparel described in claim 1 wherein the user interface devices integrated may be any combination or arrangement of one or more of mechanical, electrical or optical design and function.

18. The brace device described in claim 7 wherein the user interface devices integrated may be any combination or arrangement of one or more of mechanical, electrical or optical design and function.
